(19) United States
(12) Patent Application Publication
(10) Pub. No.: US 2004/0151459 A1
(43) Pub. Date: Aug. 5, 2004

(54) Method of polarisation compensation in grating- and phasar-based devices by using over-layer deposited on the compensating region to modify local slab waveguide birefringence

(76) Inventors: Pavel Cheben, Ottawa (CA); Siegfried Janz, Ottawa (CA); Dan-Xia Xu, Gloucester (CA); Andre Delage, Gloucester (CA); Lynden Erickson, Cumberland (CA); Boris Lamontage, Ottawa (CA); Sylvain Charbonneau, Cumberland (CA)

Correspondence Address: MARKS & CLERK, P.O. BOX 957, STATION B, OTTAWA, ON, K1P 5S7, CA

(21) Appl. No.: 10/478,965

(22) PCT Filed: May 28, 2002
(86) PCT No.: PCT/CA02/00782

(30) Foreign Application Priority Data
May 28, 2001 (CA) 2,349,044

(51) Int. Cl. G02B 6/10

(52) U.S. Cl. 385/129

(57) ABSTRACT

The method consists of creating a compensating region within the slab waveguide region, with effective TE and TM mode refractive indices of the compensating region higher than those of the original slab waveguide. Such change in refractive indices is achieved by deposition of an over-layer on the compensating region.

### BACKGROUND OF THE INVENTION

1. Field of the Invention

This invention relates to the field of photonics, and in particular to a method of polarisation compensation in grating- and phasar-based devices.

2. Description of Related Art

As the most widely used optical fibres do not preserve polarization, it is important that optical components used with optical fibres are polarization independent. In phasar-based devices, polarization independence is achieved if both TE and TM fundamental modes propagate in the arrayed waveguide section with the same propagation constants, and thus the wavelengths of the corresponding modes (measured in the waveguides) are identical. A difference in propagation constant arising from the waveguide birefringence will result in a frequency shift Δf between TE and TM spectra of a demultiplexer, according to:

$$Δ f \approx f \frac{{N}_{te} - {N}_{tm}}{{N}_{te}^{g}} ,$$

where: Δf is the central frequency, Nₜₑ and Nₜₘ are the effective waveguide indices for TE and TM polarization, and Nₜₑ^{g} is the group index of the waveguide TE mode.

Grating-based devices are polarization independent if both TE and TM modes have the same propagation constant in the slab region and the grating efficiency (including diffraction and reflection/transmission properties of the grating) is polarization independent.

In practical devices, these conditions are rarely satisfied due to material and waveguide birefringence and polarization dependent grating properties. Polarization compensation techniques are thus required to achieve polarization insensitive operation, including elimination of polarization dependent wavelength shift.

Several techniques can be used to reduce the polarization dependent wavelength shift. These include insertion of a half-wave plate in the middle of the waveguide array (H. Takahashi et al., Opt. Lett. Vol. 17,499,1992), dispersion matching with adjacent diffraction orders (M. Zirngibl et al., Electron. Lett. Vol. 29, 201, 1992), special layer structure with low birefringence (H. Bissessur et al., Electron. Lett. Vol. 30, 336, 1994), inserting a waveguide section with a different birefringence in the phased array (M. Zirngibl et al., Electron. Lett. Vol. 31, 1662, 1995), adding polarization splitter at the input of the AWG (M. K. Smit and C. van Dam, IEEE Journ. of Select. Top. in Quant. Electr. Vol 5, 236, 1996), or etching compensating region in slab waveguides (J. -J. He et at., IEEE Photon. Tech. Lett. Vol. 11, 224, 1999).

The above outlined techniques suffer from drawbacks ranging from fabrication difficulties to limitation to special devices, materials and operating conditions. The compensator etched in slab region is a particularly attractive easy-to-fabricate device, but it results in an extra insertion loss penalty and it may not provide a sufficient compensation for the materials and devices with large polarization dependent wavelength shifts.

### SUMMARY OF THE INVENTION

This invention provides a method for compensation of polarization dependent wavelength shift in grating- and phasar-based devices, such as multiplexer/demultiplexers for use in wavelength division multiplexing. The method consists of creating a compensating region within the slab waveguide region, with effective TE and TM mode refractive indices of the compensating region higher than those of the original slab waveguide. Such as change in refractive index is achieved by deposition of an over-layer, which is typically prsim-shaped, on the compensating region.

Accordingly in one aspect the present invention provides a method of effecting polarization compensation in a photonic device having a slab waveguide, comprising forming a compensating overlayer on a portion of said slab waveguide providing a compensating region.

Preferably, the compensating region has effective refractive indices for TE and TM modes of propagation higher than those of the remaining portion of the slab waveguide so as to compensate for the different refractive indices of said TE and TM modes.

In order to eliminate the polarization dependent wavelength shift δλ, it must be assured that the wavefronts corresponding to both TM and TE slab modes have the same tilt near the focal curve, thus converging to the same position of the latter. In this invention, this is achieved by deposition of an overlayer on a compensating region within the original slab waveguide region while effective refractive indices of the compensating region for TE and TM polarizations are higher than the corresponding effective indices of the original slab region.

This yields a compensation device with δnₛ>δn_{c}, where δnₛ=n_{s,te}−n_{s,tm} and δn_{c}=n_{c,te}−n_{c,tm} are the effective refractive index birefringences of the slab waveguide and the compensating region, respectively; n_{s,te} and n_{s,tm} are effective TE and TM refractive indices, respectively, of the slab waveguide; and n_{c,te} and n_{c,tm} are effective TE and TM refractive indices, respectively, of the compensating region.

The invention is based on the compensation of polarization dependent wavelength shift by an overlayer deposited on a compensating region located within the slab waveguide of phasar- or grating-based devices.

The invention discloses a method of compensating optical devices by using over-layer deposited on the compensating region to modify local slab waveguide birefringence.

In a further aspect the invention provides a photonic device as claimed in claim 9, wherein said compensating region has effective refractive indices for TE and TM modes of propagation higher than those of the remaining portion of the slab waveguide so as to compensate for the different refractive indices of said TE and TM modes.

### BRIEF DESCRIPTION OF THE DRAWINGS

The invention will now be described in more detail, by way of example, only with reference to the accompanying drawings, in which:-

FIG. 1 is a cross sectional view of the slab waveguide forming part of an arrayed waveguide grating (AWG);

FIG. 2 shows the experimental results for an overlayer compensated SOI AWG; and

FIG. 3 shows the layout of an AWG with a compensating overlayer on the slab waveguide.

### DETAILED DESCRIPTION OF THE INVENTION

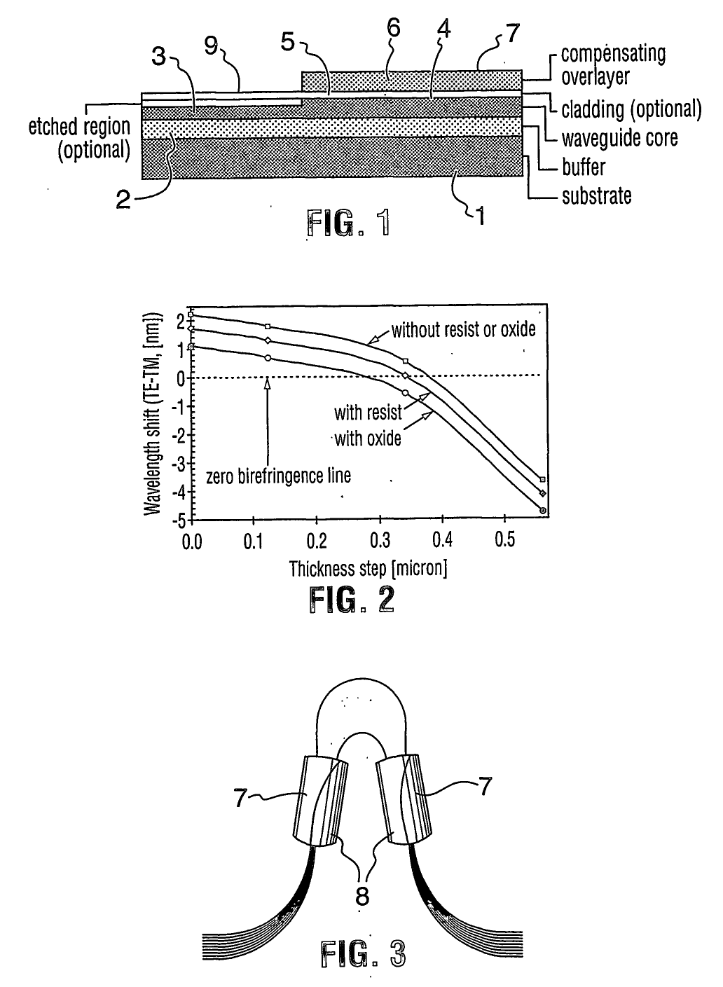

Photonic devices, such as echelle gratings and phasar devices employ slab regions to define a waveguide or other component of the device. As shown in FIG. 1, which employs silicon-on-insulator (SOI) technology, a silica slab waveguide is formed on a silicon substrate 1. The slab waveguide consists of a buffer layer 2, a core layer 3, and a cladding layer 5. The layers 2, 3 and 5 are made of silicon dioxide in a conventional manner. The silicon dioxide can be doped, for example, with phosphorus, to provide the desired refractive indices for the waveguide components. A prism-shaped compensating overlayer 7, which is this embodiment is also silicon dioxide, is formed over a portion of the slab waveguide as shown in FIGS. 1 and 3. The overlayer 7 compensates for the different effective refractive indices of the TE and TM modes. If desired, an optional etched region 9 can be formed to enhance the compensation effect. The etched region 9 can extend into the waveguide core 4.

FIG. 2 shows an example of experimental results on polarization compensation by using this method in a multiplexing/demultiplexing device fabricated on silicon-on-insulator (SOI) platform (FIG. 3). FIG. 3 shows an arrayed waveguide device with the compensating region 8 on input and output couplers 8. However, the invention is also applicable to an echelle grating, which employs a single slab waveguide as the input and output device.

The polarization dependent wavelength shift δλ=λtₑ−λtₘ is controlled by depositing the overlayer 7 on the compensating region. The effectiveness of this technique will be apparent from FIG. 2 in regimes with different values of pre-compensated wavelength shift δλ raging from 2.2 to −3.6 nm.

In FIG. 2, the x-axis represents the “thickness step”, which is the difference between the thickness of the waveguide core in the compensator and the slab regions respectively. The y-axis represents the wavelength shift in nm between the TE and TM modes of propagation. In this particular example, the overlayer 7 was silicon dioxide or photoresist, but other materials with suitable refractive indices can be employed, such as dielectrics and polymers. The silicon dioxide layer is the most effective at providing polarization compensation.

An SOI platform with a large pre-compensated value of the polarization dependent wavelength shift was chosen in order to exemplify the effectiveness of the compensation scheme; the same technique can though be used in other platforms, including but not limited to silica-on-silicon.

One skilled in the art will appreciate that many further embodiments of the invention are possible within the scope of the appended claims.

1. A method of effecting polarization compensation in a photonic device having a slab waveguide, comprising forming a compensating overlayer on a portion of said slab waveguide providing a compensating region.

2. A method as claimed in claim 1, wherein said compensating region has effective refractive indices for TE and TM modes of propagation higher than those of the remaining portion of the slab waveguide so as to compensate for the different refractive indices of said TE and TM modes.

3. A method as claimed in claim 1, wherein said slab waveguide comprises a buffer layer, a core layer, and a cladding layer, and said compensating layer is formed on said cladding layer over the compensating region of said slab waveguide.

4. A method as claimed in claim 3, wherein said compensating layer is silicon dioxide.

5. A method as claimed in claim 3, wherein said compensating layer is photoresist.

6. A method as claimed in any one of claims 1 to 5, wherein said buffer, core, and cladding layers are silicon dioxide.

7. A method as claimed in any one of claims 1 to 6, wherein said buffer layer is formed on a silicon-on-insulator substrate.

8. A method as claimed in any one of claims 1 to 7, further comprising etching into a portion of said slab waveguide.

9. A photonic device comprising a slab waveguide, and a compensating overlayer on a portion of said slab waveguide to a compensating region.

10. A photonic device as claimed in claim 9, wherein said compensating region has effective refractive indices for TE and TM modes of propagation higher than those of the remaining portion of the slab waveguide so as to compensate for the different refractive indices of said TE and TM modes.

11. A photonic device as claimed in claim 10, wherein said slab waveguide comprises a buffer layer, a core layer, and a cladding layer, and said compensating layer is formed on said cladding layer over the compensating region of said slab waveguide.

12. A photonic device as claimed in claim 11, wherein said compensating layer is silicon dioxide.

13. A photonic device as claimed in claim 11, wherein said compensating layer is photoresist.

14. A photonic device as claimed in any one of claims 9 to 13, wherein said buffer, core, and cladding layers are silicon dioxide.

15. A photonic device as claimed in any one of claims 9 to 14, wherein said buffer layer lies over a silicon-on-insulator substrate.

16. A photonic device as claimed in claim 11, wherein the slab waveguide also has an etched region extending into said core layer.

17. A photonic device as claimed in any one of claims 9 to 16, which is an arrayed waveguide multiplexer/demultiplexer.

18. A photonic device as claimed in any one of claims 9 to 16, which is an echelle grating multiplexer/demultiplexer.
